(19) United States
(12) Patent Application Publication
(10) Pub. No.: US 2007/0017733 A1
(43) Pub. Date: Jan. 25, 2007

(54) Vehicle power steering system

(76) Inventors: Joey D. Edson, Seymour, MO (US); Klaus G. Engel, Waterloo (CA); Randy C. Foster, Strafford, MO (US); Aleksandar Jankovic, Springfield, MO (US); Richard J. Meckstroth, Vonore, TN (US)

Correspondence Address: DAYCO PRODUCTS, LLC, 1 PRESTIGE PLACE, MIAMISBURG, OH, 45342, US

(21) Appl. No.: 11/150,171

(22) Filed: Jun. 13, 2005

(51) Int. Cl. B62D 5/04

(52) U.S. Cl. 180/444

(57) ABSTRACT

A vehicle power steering system includes a sweep magnet, at least one Hall sensor, and at least one hydraulic-power-steering-system valve. The sweep magnet is fixedly connected to a first end of a twistable steering torsion bar wherein the first end is fixedly connected to a vehicle steering wheel. The at-least-one Hall sensor is fixedly connected to a second end of the steering torsion bar. The at-least-one Hall sensor has an output and is positioned proximate the sweep magnet such that the output is a function of steering wheel torque when the vehicle steering wheel is turned by a driver. The at-least-one hydraulic-power-steering-system valve is operatively connected to the output.

### TECHNICAL FIELD

The present invention relates generally to vehicles, and more particularly to a vehicle power steering system.

### BACKGROUND OF THE INVENTION

Conventional vehicle power steering systems, such as ones used in automobiles and light trucks, use a continuously operating hydraulic pump and a twistable steering torsion bar connected at one end to a vehicle steering wheel and connected at the other end to the pinion gear of the steering system. A driver turning the vehicle steering wheel results in twisting of the steering torsion bar which physically opens and closes hydraulic flow-control valves which results in high pressure fluid flowing to one side or the other side of a hydraulic piston which moves the wheel tie rods to turn the vehicle wheels. Unsuccessful attempts at designing an electric-controlled hydraulic system, which involved the steering torsion bar in the valve control loop to produce a pressure level, are known.

Still, scientists and engineers continue to seek improved vehicle power steering systems.

### SUMMARY OF THE INVENTION

A first expression of a first embodiment of the invention is for a vehicle power steering system including a sweep magnet, at least one Hall sensor, and at least one hydraulic-power-steering-system valve. The sweep magnet is fixedly connected to a first end of a twistable steering torsion bar wherein the first end is fixedly connected to a vehicle steering wheel. The at-least-one Hall sensor is fixedly connected to a second end of the steering torsion bar. The at-least-one Hall sensor has an output and is positioned proximate the sweep magnet such that the output is a function of steering wheel torque when the vehicle steering wheel is turned by a driver. The at-least-one hydraulic-power-steering-system valve is operatively connected to the output.

A second expression of a first embodiment of the invention is for a vehicle power steering system including: a first cylinder; a second cylinder; hydraulic-power-steering-system, electrically-actuated, first and second pressure-control valves; and a controller. The first cylinder has a sweep magnet and is fixedly connected to a first end of a twistable steering torsion bar wherein the first end is fixedly connected to a vehicle steering wheel. The second cylinder has circumferentially spaced apart first and second Hall sensors and is fixedly connected to a second end of the steering torsion bar. The second cylinder is substantially coaxially aligned with the first cylinder. The first and second Hall sensors have corresponding first and second voltage outputs and are positioned proximate the sweep magnet such that the first and second voltage outputs are functions of steering wheel torque when the vehicle steering wheel is turned by a driver. The controller calculates a voltage difference between the first voltage output and the second voltage output, outputs a first control voltage to the first pressure-control valve if the voltage difference is positive, and outputs a second control voltage to the second pressure-control valve if the voltage difference is negative.

An expression of a second embodiment of the method invention is for a vehicle power steering system including: a first cylinder; a second cylinder; a hydraulic-power-steering-system, electrically-actuated pressure-control valve; and a controller. The first cylinder has a sweep magnet and is fixedly connected to a first end of a twistable steering torsion bar wherein the first end is fixedly connected to a vehicle steering wheel. The second cylinder has circumferentially spaced apart first and second Hall sensors and is fixedly connected to a second end of the steering torsion bar. The second cylinder is substantially coaxially aligned with the first cylinder. The first and second Hall sensors have corresponding first and second voltage outputs and are positioned proximate the sweep magnet such that the first and second voltage outputs are functions of steering wheel torque when the vehicle steering wheel is turned by a driver. The controller calculates a voltage difference between the first voltage output and the second voltage output and outputs a control voltage to the pressure-control valve based on the voltage difference.

Several benefits and advantages are derived from one or more of the expressions of the embodiments of the invention. In one example, having at least one Hall sensor to sense steering wheel torque enables the at-least-one hydraulic-power-steering system valve to be electrically actuated and enables the power steering system to operate on demand which saves on fuel consumption, as can be appreciated by those skilled in the art. In the same or a different example, having valve control based on the output of a Hall sensor which depends on steering wheel torque and which is adjusted for measured fluid pressure, allows feedback control that converges on a desired pressure avoiding high frequency cycling events felt in the steering wheel of unsuccessful electric-controlled power steering systems which include a driver-to-vehicle feedback loop, as can be appreciated by the artisan.

### SUMMARY OF THE DRAWINGS

FIG. 1 is a schematic diagram of a first embodiment of a vehicle power steering system of the invention;

FIG. 2 is a cutaway view of a portion of the power steering system of FIG. 1 including the steering torsion bar;

FIG. 3 is a detailed view of the electro-hydraulic assembly of the power steering system of FIG. 1;

FIG. 4 is a perspective view of the first cylinder, including the sweep magnet, and the second cylinder, including the first and second Hall sensors, of the power steering system of FIG. 2, wherein the cylinders are shown separated prior to assembly;

FIG. 5 is a top plan schematic view of the sweep magnet and Hall sensor portion of the power steering system of FIG. 2 also showing the biasing magnets;

FIG. 6 is an explanatory block diagram of the control logic for operating the power steering system of FIG. 1;

FIG. 7 is a schematic diagram of a second embodiment of a vehicle power steering system of the invention;

FIG. 8 is a cutaway view of a portion of the power steering system of FIG. 7 including the steering torsion bar;

FIG. 9 is a detailed view of a portion of the electro-hydraulic assembly of the power steering system of FIG. 7;

FIG. 10 is a perspective view of the first cylinder, including the sweep magnet, and the second cylinder, including the first and second Hall sensors, of the power steering system of FIG. 8, wherein the cylinders are shown separated prior to assembly;

FIG. 11 is a top plan schematic view of the sweep magnet and Hall sensor portion of the power steering system of FIG. 8 also showing the biasing magnets;

FIG. 12 is an explanatory block diagram of the control logic for operating the power steering system of FIG. 7;

FIG. 13 is a graph plotting the relative magnetic flux density at (and the relative voltage output of) a Hall sensor versus the relative midpoint separation distance in inches between the Hall sensor and the sweep magnet; and

FIG. 14 is a graph plotting the first and second voltage outputs of the first and second Hall sensors versus the sensor-to-sweep-magnet displacement in degrees; and

FIG. 15 is a graph plotting a typical pressure to a turn-side of the hydraulic piston in psi (pounds per square inch) versus Hall sensor voltage output.

### DESCRIPTION OF THE PREFERRED EMBODIMENTS

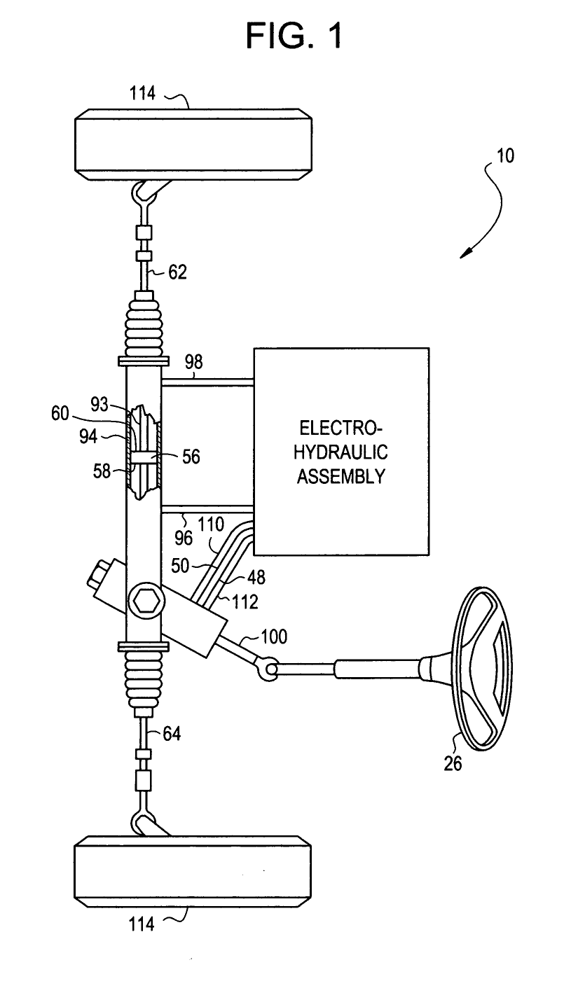

Referring now to the drawings, FIGS. 1-5 illustrate a first embodiment of the present invention. A first expression of the embodiment of FIGS. 1-5 is for a vehicle power steering system 10 including a sweep magnet 12, at least one Hall sensor 14 and 16, and at least one hydraulic-power-steering-system valve 18 and 20. The sweep magnet 12 is fixedly connected to a first end 22 of a twistable steering torsion bar 24 wherein the first end 22 is fixedly connected to a vehicle steering wheel 26. The at least one Hall sensor 14 and 16 is fixedly connected to a second end 28 of the steering torsion bar 24. The at-least-one Hall sensor 14 and 16 has an output 30 and 32 and is disposed proximate the sweep magnet 12 such that the output 30 and 32 is a function of steering wheel torque when the vehicle steering wheel 26 is turned by a driver. The at least one hydraulic-power-steering-system valve 18 and 20 is operatively connected to the output 30 and 32.

The term “connected” includes directly connected and indirectly connected. Describing the sweep magnet 12 as fixedly connected to a first end 22 of a twistable steering torsion bar 24 means the sweep magnet 12 is fixedly connected directly or indirectly to the first end 22 without such connection path having to pass through the second end 28 of the steering torsion bar 24. Likewise, describing the at-least-one Hall sensor 14 and 16 as fixedly connected to a second end 28 of the steering torsion bar 24 means the at-least-one Hall sensor 14 and 16 is fixedly connected directly or indirectly to the second end 28 without such connection path having to pass through the first end 22 of the steering torsion bar 24. The terminology “Hall sensor” means Hall effect sensor as is known in the sensor art.

In one enablement of the first expression of the embodiment of FIGS. 1-5, the at-least-one Hall sensor 14 and 16 includes first and second Hall sensors 14 and 16. In one variation, the output 30 and 32 includes a first output 30 of the first Hall sensor 14 and a second output 32 of the second Hall sensor 16. In one modification, the at-least-one hydraulic-power-steering-system valve 18 and 20 is operatively connected to at least one of the first and second outputs 30 and 32 through a controller 34. Having two Hall sensors instead of a single Hall sensor overcomes any deadband problems that may be present in certain applications, as can be appreciated by the artisan.

In one implementation of the first expression of the embodiment of FIGS. 1-5, the at least-one hydraulic-power-steering-system valve 18 and 20 includes an electrically actuated first valve 18 and an electrically actuated second valve 20. In one variation, the first valve 18 is operatively connected to the first and second outputs 30 and 32 and the second valve 20 is operatively connected to the first and second outputs 30 and 32. In the same or a different implementation, the at-least-one hydraulic-power-steering-system valve 18 and 20 is a pressure control valve. In the same or a different implementation, the vehicle power steering system 10 includes first and second biasing magnets 36 and 38 fixedly connected, respectively, to the first and second Hall sensors 14 and 16 to create a baseline magnetic field.

A second expression of the embodiment of FIGS. 1-5 is for a vehicle power steering system 10 including: a first cylinder 40; a second cylinder 42; hydraulic-power-steering-system, electrically-actuated, first and second pressure-control valves 44 and 46; and a controller 34. The first cylinder 40 has a sweep magnet 12 and is fixedly connected to a first end 22 of a twistable steering torsion bar 24 wherein the first end 22 is fixedly connected to a vehicle steering wheel 26. The second cylinder 42 has circumferentially spaced apart first and second Hall sensors 14 and 16 and is fixedly connected to a second end 28 of the steering torsion bar 24. The second cylinder 42 is substantially coaxially aligned with the first cylinder 40. The first and second Hall sensors 14 and 16 have corresponding first and second voltage outputs 48 and 50 and are disposed proximate the sweep magnet 12 such that the first and second voltage outputs 48 and 50 are functions of steering wheel torque when the vehicle steering wheel 26 is turned by a driver. The controller 34 calculates a voltage difference between the first voltage output 48 and the second voltage output 50, outputs a first control voltage 52 to the first pressure-control valve 44 if the voltage difference is positive, and outputs a second control voltage 54 to the second pressure-control valve 46 if the voltage difference is negative.

In one example, the voltage (or a pressure) difference is equal to the first voltage (or pressure) output minus the second voltage (or pressure) output. In a different example, the voltage (or a pressure) difference is equal to the second voltage (or pressure) output minus the first voltage (or pressure) output.

In one implementation of the second expression of the embodiment of FIGS. 1-5, the vehicle power steering system 10 also includes a hydraulic piston 56 having a right-turn side 58 and a left-turn side 60 and operatively connected to right and left wheel tie rods 62 and 64. The first pressure control valve 44 is operatively connected to the right-turn side 58 of the hydraulic piston 56 and the second pressure-control valve 46 is operatively connected to the left-turn side 60 of the hydraulic piston 56. In one variation, the vehicle power steering system 10 also includes a first pressure transducer 66 having a first pressure output 68 and operatively connected to the right-turn side 62 of the hydraulic piston 56 and a second pressure transducer 70 having a second pressure output 72 and operatively connected to the left-turn side 60 of the hydraulic piston 56.

In one application of the second expression of the embodiment of FIGS. 1-5, the controller 34 calculates a pressure difference between the first pressure output 68 and the second pressure output 72. In one variation, the controller 34 adjusts the voltage difference in a predetermined manner based on a comparison of the pressure difference to the voltage difference. In one example, a predetermined scale factor is used, wherein the voltage difference is adjusted to equal the predetermined scale factor times the pressure difference, and wherein the predetermined scale factor is experimentally determined, as is within the level of skill of the artisan. In one modification, the controller calculates the first and second control voltages based on the adjusted voltage difference. In one example, the first and second control voltages each are time-tuned, filtered, and proportional to the absolute value of the adjusted voltage difference, such time-tuning, filtering, and proportionality being experimentally determined, as is within the level of skill of the artisan.

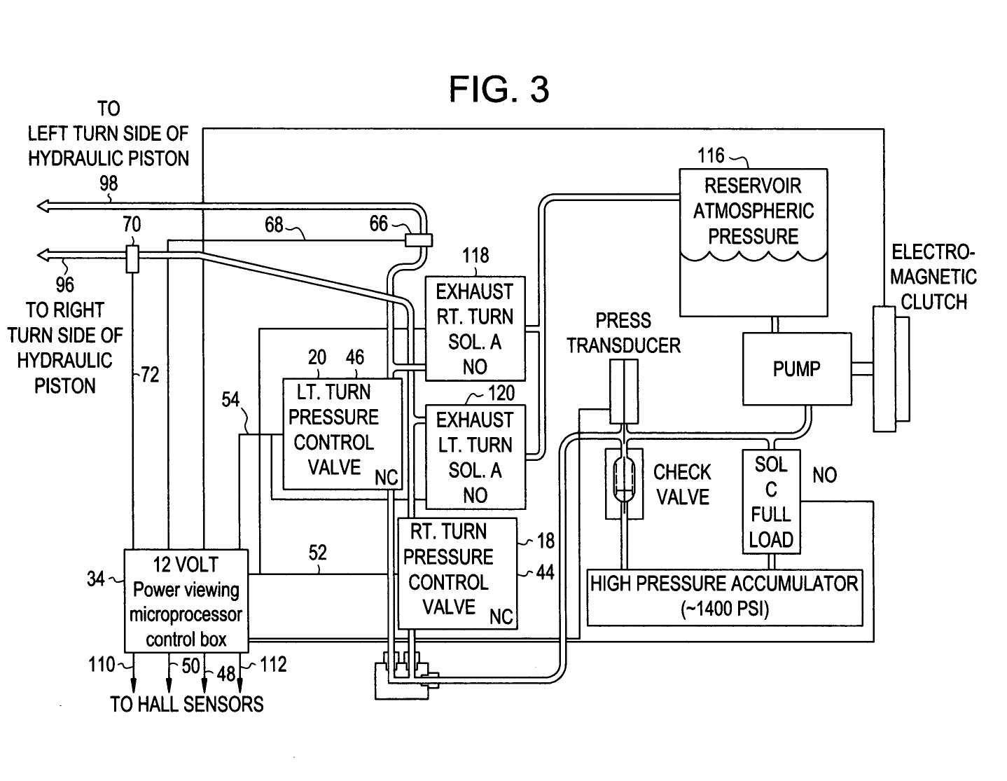

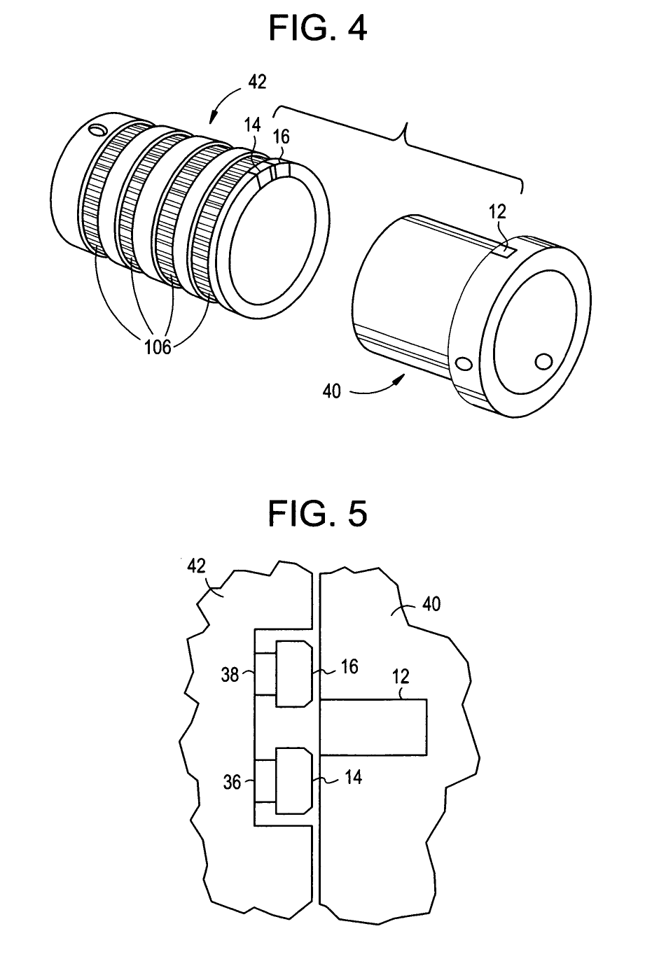

In one arrangement of the second expression of the embodiment of FIGS. 1-5, the second cylinder 42 includes first and second biasing magnets 37 and 38 (shown in FIGS. 3-4) disposed, respectively, under the first and second Hall sensors 14 and 16 to create a baseline magnetic field.

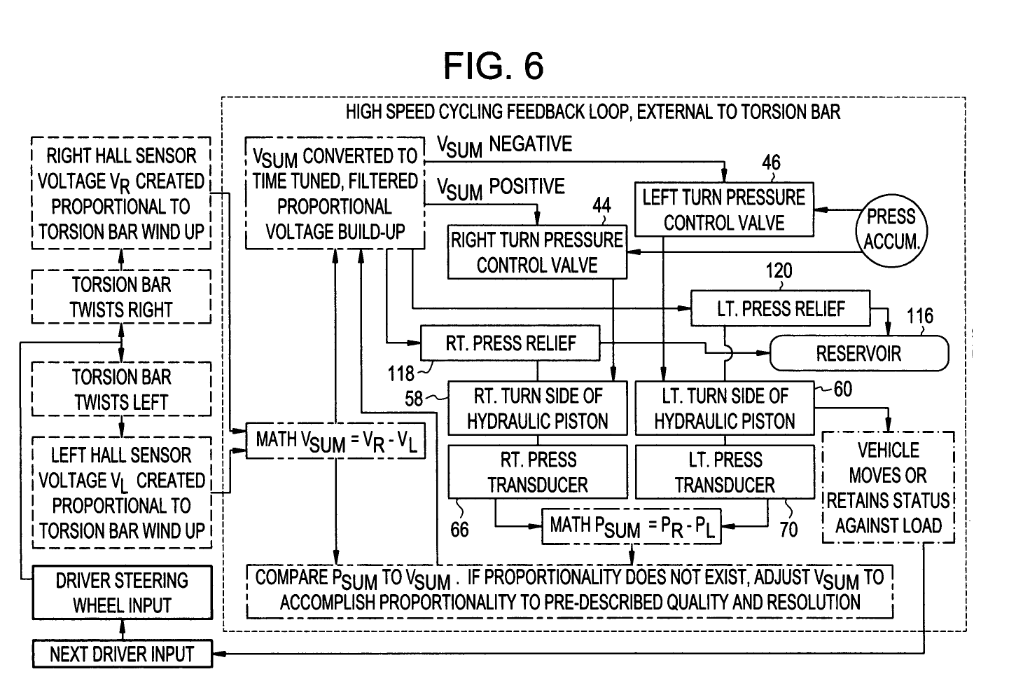

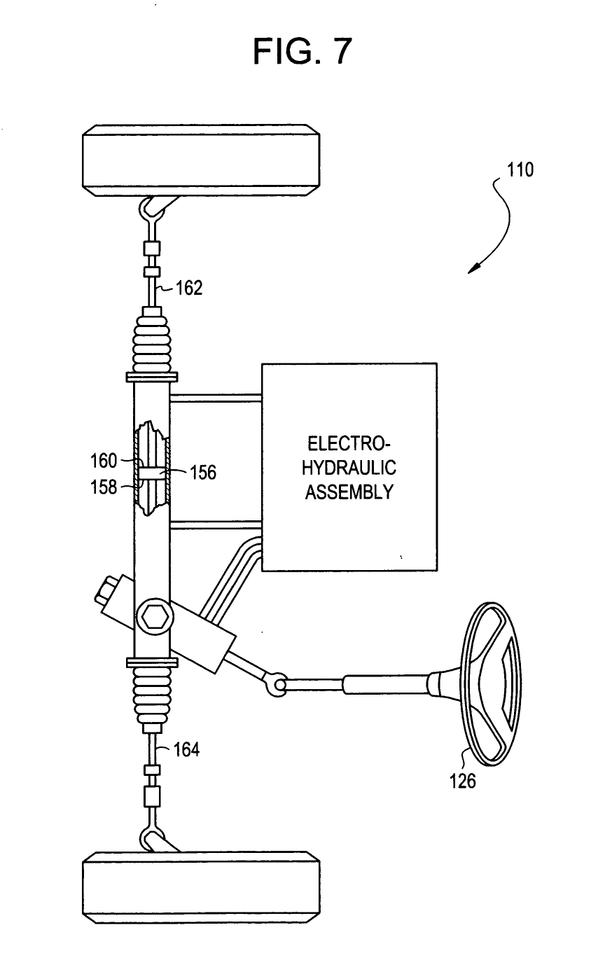

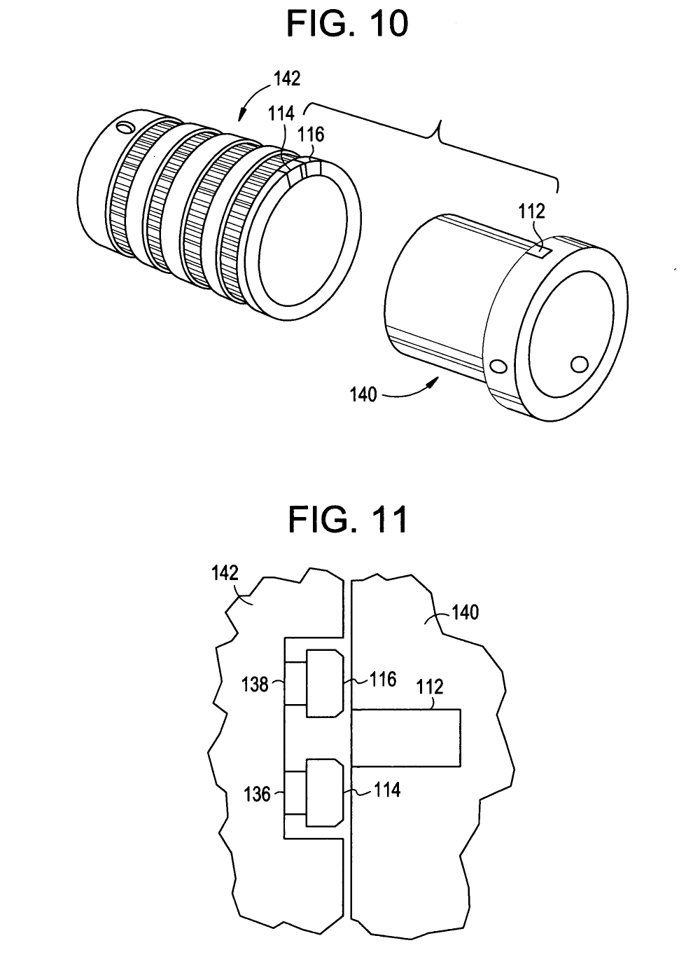

Referring again to the drawings, FIGS. 6-10 illustrate a second embodiment of the present invention. An expression of the embodiment of FIGS. 6-10 is for a vehicle power steering system 110 including: a first cylinder 140; a second cylinder 142; a hydraulic-power-steering-system, electrically-actuated pressure-control valve 178; and a controller 134. The first cylinder 140 has a sweep magnet 112 and is fixedly connected to a first end 122 of a twistable steering torsion bar 124 wherein the first end 122 is fixedly connected to a vehicle steering wheel 126. The second cylinder 142 has circumferentially spaced apart first and second Hall sensors 114 and 116 and is fixedly connected to a second end 128 of the steering torsion bar 124. The second cylinder 142 is substantially coaxially aligned with the first cylinder 140. The first and second Hall sensors 114 and 116 have corresponding first and second voltage outputs 148 and 150 and are disposed proximate the sweep magnet 112 such that the first and second voltage outputs 148 and 150 are functions of steering wheel torque when the vehicle steering wheel 126 is turned by a driver. The controller calculates a voltage difference between the first voltage output 148 and the second voltage output 150 and outputs a control voltage 180 to the pressure-control valve 178 based on the voltage difference.

In one implementation of the expression of the embodiment of FIGS. 6-10, the vehicle power steering system 110 also includes a hydraulic piston 156 having a right-turn side 158 and a left-turn side 160 and operatively connected to right and left wheel tie rods 162 and 164, and the vehicle power steering system 110 also includes right and left electric valves 182 and 184. The right electric valve 182 is disposed between and in fluid communication with the pressure control valve 178 and the right-turn side 158 of the hydraulic piston 156, and the left electric valve 184 is disposed between and in fluid communication with the pressure control valve 178 and the left-turn side 160 of the hydraulic piston 156. The controller 134 opens the right or left electric valve 182 or 184 depending on the sign of the voltage difference. In one variation, the vehicle power steering system 110 also includes a first pressure transducer 166 having a first pressure output 168 and operatively connected to the right-turn side 162 of the hydraulic piston 156 and a second pressure transducer 170 having a second pressure output 172 and operatively connected to the left-turn side 160 of the hydraulic piston 156.

In one application of the expression of the embodiment of FIGS. 6-10, the controller 134 calculates a pressure difference between the first pressure output 168 and the second pressure output 172. In one variation, the controller 134 adjusts the voltage difference in a predetermined manner based on a comparison of the pressure difference to the voltage difference. In one example, a predetermined scale factor is used, wherein the voltage difference is adjusted to equal the predetermined scale factor times the pressure difference, and wherein the predetermined scale factor is experimentally determined, as is within the level of skill of the artisan. In one modification, the controller calculates the first and second control voltages based on the adjusted voltage difference. In one example, the first and second control voltages each are time-tuned, filtered, and proportional to the absolute value of the adjusted voltage difference, such time-tuning, filtering, and proportionality being experimentally determined, as is within the level of skill of the artisan.

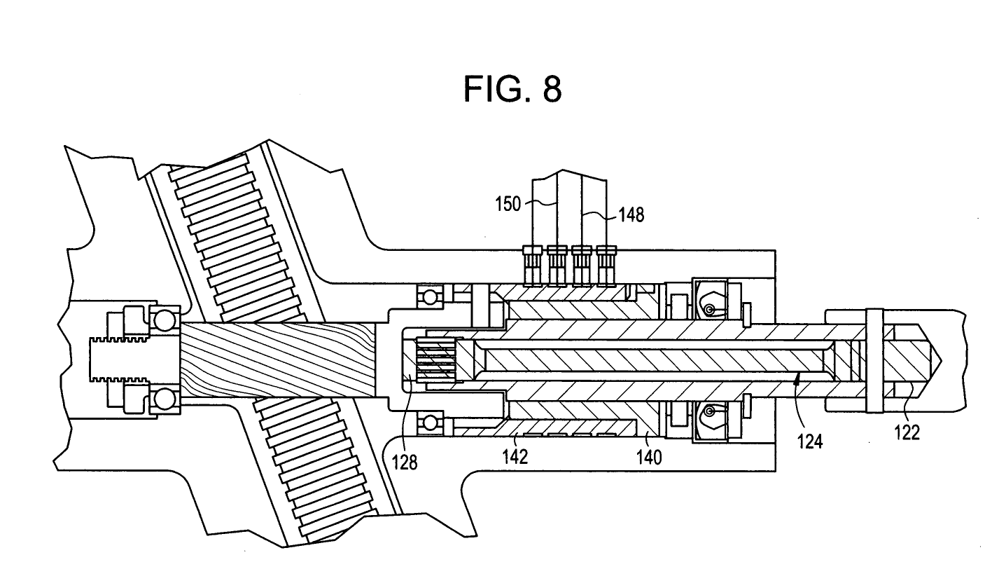

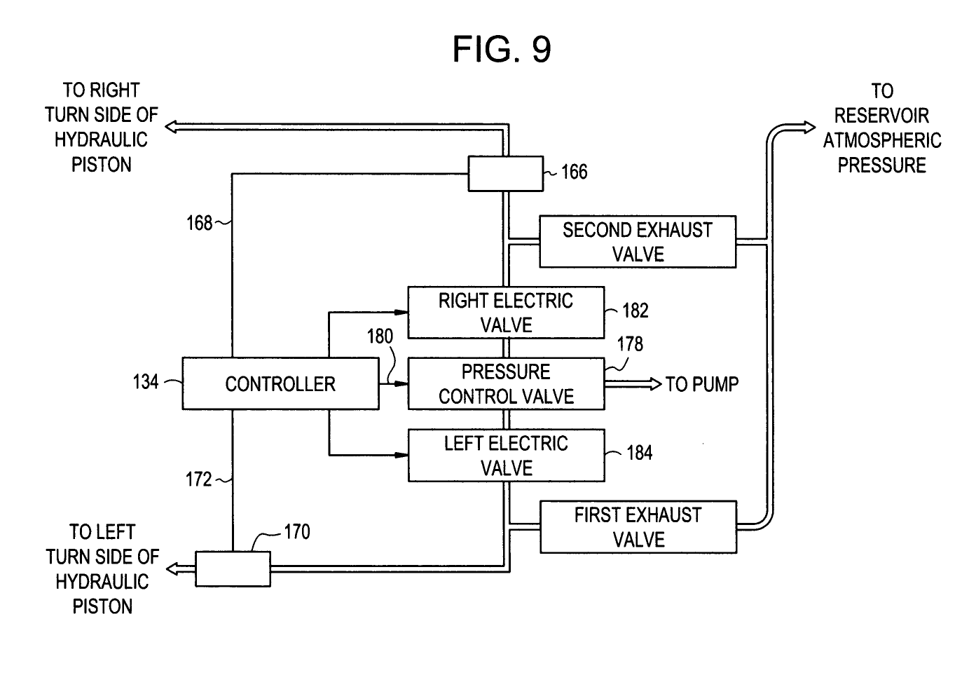

In one arrangement of the expression of the embodiment of FIGS. 6-10, the second cylinder 142 includes first and second biasing magnets 136 and 138 (shown in FIGS. 8-9) disposed, respectively, under the first and second Hall sensors 114 and 116 to create a baseline magnetic field.

Several benefits and advantages are derived from one or more of the expressions of the embodiments of the invention. In one example, having at least one Hall sensor to sense steering wheel torque enables the at-least-one hydraulic-power-steering system valve to be electrically actuated and enables the power steering system to operate on demand which saves on fuel consumption, as can be appreciated by those skilled in the art. In the same or a different example, having valve control depend on the output of a Hall sensor which depends on steering wheel torque, and which is adjusted for measured fluid pressure, allows feedback control that converges on a desired pressure avoiding high frequency cycling events felt in the steering wheel of conventional power steering systems which include a driver-to-vehicle feedback loop, as can be appreciated by the artisan.

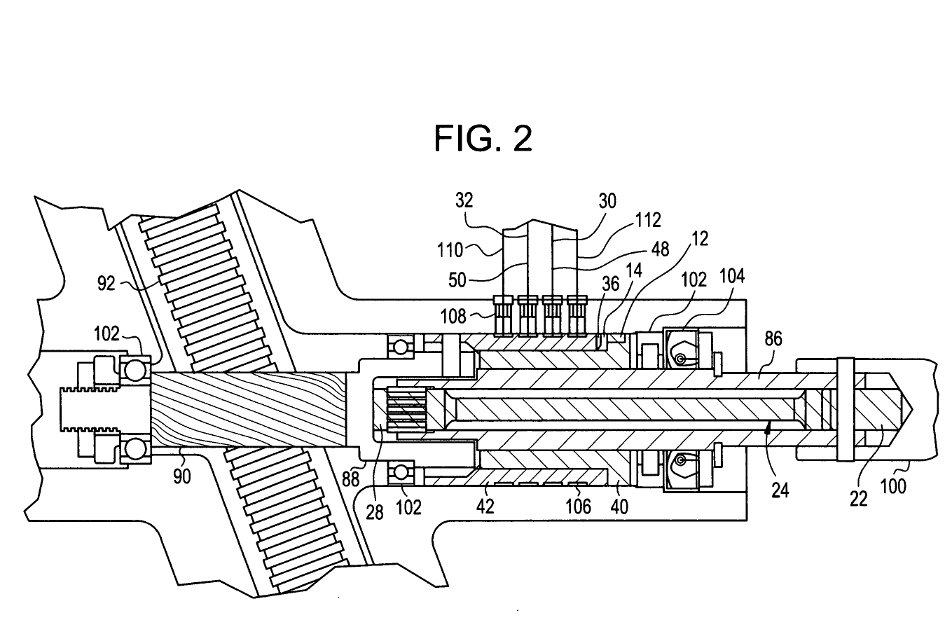

The following paragraphs (including references to figures) present a detailed description of one enablement of the second expression of the embodiment of FIGS. 1-5. As shown in FIGS. 1-2, the first cylinder 40 is attached to the steering wheel tube 86 which is attached to the first end 22 of the steering torsion bar 24. The second cylinder 42 is attached to the pinion shaft 88 which is attached to the second end 28 of the steering torsion bar 24. The pinion shaft 88 is attached to the pinion gear 90 which engages the rack gear 92. The rack shaft 93 of the rack gear 92 moves the right and left wheel tie rods 62 and 64 and is connected to the hydraulic piston 56 inside the hydraulic cylinder 94 to which is operatively attached the right-turn hydraulic line 96 on the right-turn side 58 of the hydraulic piston 56 and the left-turn hydraulic line 98 on the left-turn side 60 of the hydraulic piston 56. It is noted that the steering wheel shaft 100 is attached at one end to the vehicle steering wheel 26 and at the other end to both the first end 22 of the steering torsion bar 24 and the steering wheel tube 86. Bearings 102 and seals 104 are also shown. Four contact electric rings 106 on the second cylinder 42 and four non-rotatable contact brushes 108 provide electrical communication over four lines (positive voltage 110, ground 112, first voltage output 48 and second voltage output 50) between the controller 34 and the first and second Hall sensors 14 and 16.

The pinion gear 90 typically makes four to six revolutions as the hydraulic piston 56 moves from one end of the hydraulic cylinder 94. The sweep magnet 12 sweeps past these two Hall sensors 14 and 16 with a motion proportional to steering wheel torque. This sweep magnet is approximately 0.5 mm away from the Hall sensors in the axial direction. Since the second cylinder 42 must rotate up to six times in its full travel, spring loaded electrical contact brushes 108 are in contact with the contact electric rings 106 at all points in its travel. The relative motion of second cylinder 42 to the first cylinder 40 is proportional to the steering wheel torque because the first end of the steering torsion bar 24 is rigidly attached to the steering wheel tube 86 and the second end 28 is rigidly attached to the pinion gear 90. The steering wheel tube 86 is rigidly attached the steering wheel shaft 100. When the steering wheel torque occurs, as the vehicle steering wheel 26 is turned to steer the wheels 114, the steering torsion bar 24 twists-proportionally to the amount of torque. Thus we have relative rotational motion between the second and first cylinders 42 and 40 proportional to the steering wheel torque.

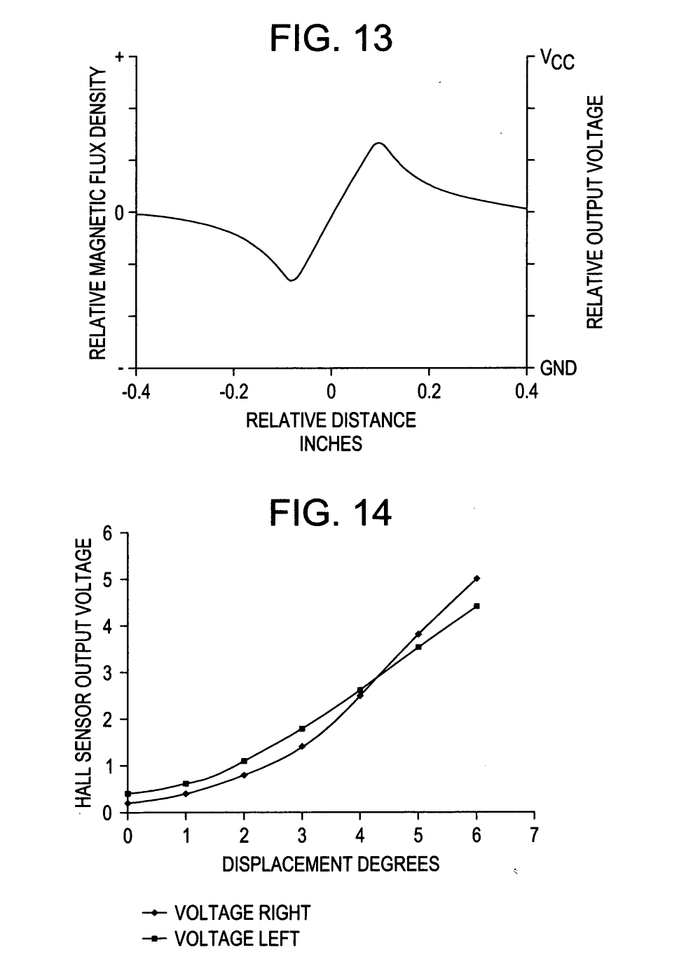

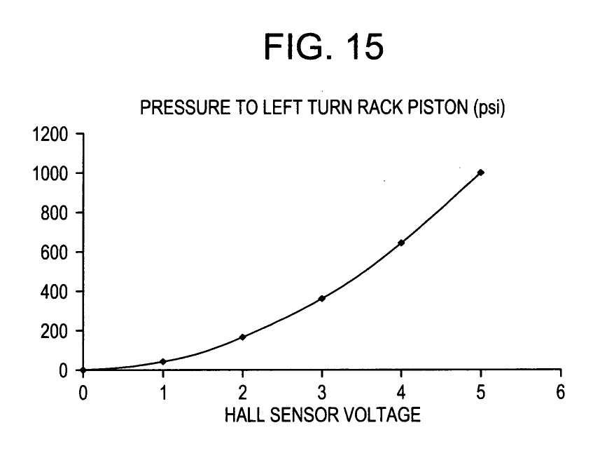

At a certain level of twist, a typical torque being 10 Newton meters, the steering wheel tube 86 solidly connects to the pinion shaft 88, and the rack gear 92 can be moved by manual steering which provides a backup to the power steering assist. This amount of twist, typically six degrees, is well below the elastic limit (yield strength) of the steering torsion bar 24. As the steering torsion bar 24 twists, the sweep magnet 12 creates a varying magnetic field in the area of the Hall Sensors 14 and 16 (see FIG. 13 which plots the relative magnetic flux density at (and the relative voltage output of) a Hall sensor versus the relative separation distance between the Hall sensor and the sweep magnet. This magnetic field results in a variable voltage (see FIG. 14 which plots the first and second voltage outputs 48 and 50 of the first and second Hall sensors 14 and 16 versus the sensor-to-sweep-magnet displacement in degrees). The voltage output 48 or 50 of a Hall sensor 14 or 16 is related to the pressure to a turn side 58 or 60 at the hydraulic piston 56 as shown in FIG. 15.

This variable voltage 48 and 50 is then processed in the controller 34 and is subsequently used to send commands to the first and second pressure-control valves 44 and 46 that control pressure to each side of the hydraulic piston 56, thus providing hydraulic assist in steering to the driver. The system uses the relative rotary motion of the pinion shaft 88 to the motion of the vehicle steering wheel 26 as a signal to actuate power steering assist in either direction based on the magnitude and direction of the relative motion.

FIG. 6 describes the use of a high frequency feedback loop to establish a pressure level consistent with the steering wheel torque, as can be understood by the artisan. In this enablement, the pressure level is converged on, external to the driver/vehicle feedback loop. An advantage of this enablement is that it avoids a high frequency cycling event that can be felt in the steering wheel.

In one example of FIG. 6, as the steering torsion bar 24 twists to the right due to torque being applied by the driver on the vehicle steering wheel 26 to the right, either the pinion gear 90 moves the rack gear 92 and relieves the torque (manual steering) or, if more torque is applied, the wind up of the steering torsion bar 24 with respect to the steering wheel shaft 100 will actuate the first Hall Sensor 14 which will send a first output voltage 48 to the microprocessor. This signal is amplified in the 12 volt power steering system controller 34 to a stronger current and becomes the first control voltage 52 which actuates the first pressure-control valve 44 (denominated “right turn pressure control valve”) in FIG. 6. This NC (Normally Closed) valve allows high pressure fluid from the high pressure accumulator to flow to the right-turn side 58 of the hydraulic piston 56, until the first pressure output (voltage) 68 of the first pressure transducer 66 indicates pressure is achieved. The pressure sensors 66 and 70 in each pressure line 96 and 98 going to the right-turn side 58 and the left-turn side 60 of the hydraulic piston 56 provide feedback so that the correct valve voltage and therefore pressure is achieved at each side of the hydraulic piston as a function of the steering torsion bar windup. This moves the hydraulic piston 56 to the right, which moves the rack shaft 93 right, which will steer the vehicle to the right. Whenever pressure is applied to one side of the hydraulic piston 56, the opposite side is fully exhausted to the reservoir 116 by the first and second exhaust valves 118 and 120. For a left turn, just the opposite sequence occurs.

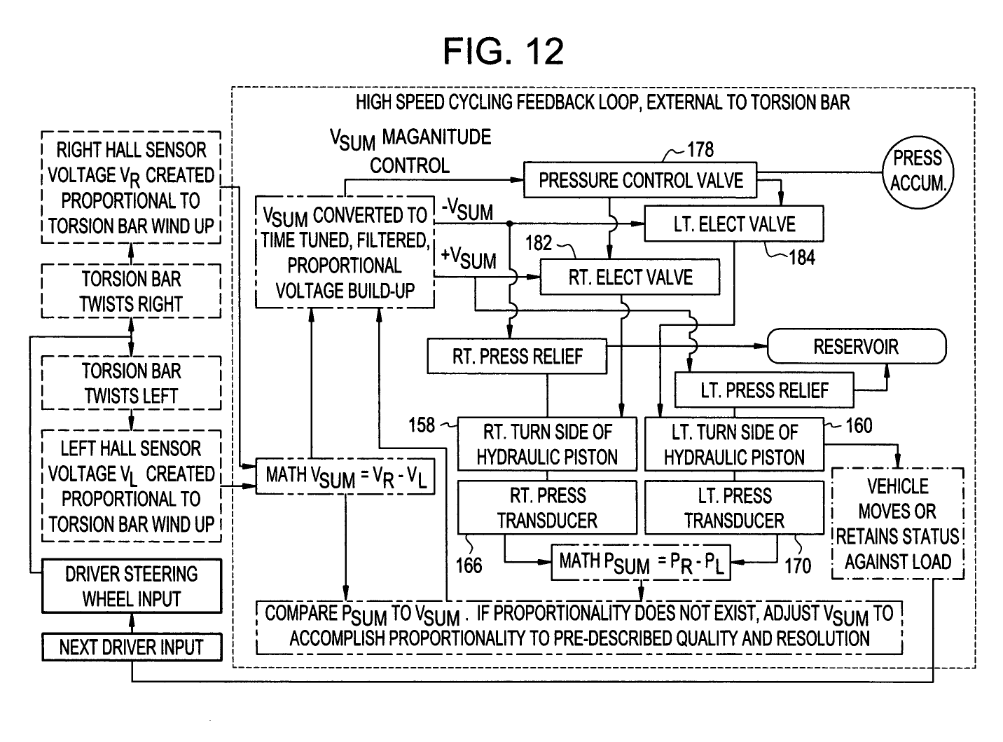

It is noted that FIG. 12 describes the use of a high frequency feedback loop which uses a single pressure-control valve 178 to establish a pressure level consistent with the steering wheel torque, as can be understood by the artisan. The single pressure-control valve 178 and right and left electric valves 182 and 184 are used to raise the pressure to the desired level of either the right-turn side or the left-turn side of the hydraulic piston 156 and to just expose the correct right or left turn side of the hydraulic piston to either this pressure or exhaust, depending on the steering wheel input.

The foregoing description of several expressions of embodiments of the invention has been presented for purposes of illustration. It is not intended to be exhaustive or to limit the invention to the precise forms and steps disclosed, and obviously many modifications and variations are possible in light of the above teaching. It is intended that the scope of the invention be defined by the claims appended hereto.

1. A vehicle power steering system comprising:
a) a sweep magnet fixedly connected to a first end of a twistable steering torsion bar wherein the first end is fixedly connected to a vehicle steering wheel;
b) at least one Hall sensor fixedly connected to a second end of the steering torsion bar, wherein the at-least-one Hall sensor has an output and is disposed proximate the sweep magnet such that the output is a function of steering wheel torque when the vehicle steering wheel is turned by a driver; and
c) at least one hydraulic-power-steering-system valve operatively connected to the output.

2. The vehicle power steering system of claim 1, wherein the at-least-one Hall sensor includes first and second Hall sensors, wherein the output includes a first output of the first Hall sensor and a second output of the second Hall sensor, and wherein the at-least-one hydraulic-power-steering-system valve is operatively connected to at least one of the first and second outputs through a controller.

3. The vehicle power steering system of claim 2, wherein the at least-one hydraulic-power-steering-system valve includes an electrically actuated first valve and an electrically actuated second valve.

4. The vehicle power steering system of claim 3, wherein the first valve is operatively connected to the first and second outputs and the second valve is operatively connected to the first and second outputs.

5. The vehicle power steering system of claim 2, wherein the at-least-one hydraulic-power-steering-system valve is a pressure control valve.

6. The vehicle power steering system of claim 2, also including first and second biasing magnets fixedly connected, respectively, to the first and second Hall sensors to create a baseline magnetic field.

7. A vehicle power steering system comprising:
a) a first cylinder having a sweep magnet and fixedly connected to a first end of a twistable steering torsion bar wherein the first end is fixedly connected to a vehicle steering wheel;
b) a second cylinder having circumferentially spaced apart first and second Hall sensors and fixedly connected to a second end of the steering torsion bar, wherein the second cylinder is substantially coaxially aligned with the first cylinder, and wherein the first and second Hall sensors have corresponding first and second voltage outputs and are disposed proximate the sweep magnet such that the first and second voltage outputs are functions of steering wheel torque when the vehicle steering wheel is turned by a driver;
c) hydraulic-power-steering-system, electrically-actuated, first and second pressure-control valves; and
d) a controller which calculates a voltage difference between the first voltage output and the second voltage output, which outputs a first control voltage to the first pressure-control valve if the voltage difference is positive, and which outputs a second control voltage to the second pressure-control valve if the voltage difference is negative.

8. The vehicle power steering system of claim 7, also including a hydraulic piston having a right-turn side and a left-turn side and operatively connected to right and left wheel tie rods, wherein the first pressure-control valve is operatively connected to the right-turn side of the hydraulic piston and the second pressure-control valve is operatively connected to the left-turn side of the hydraulic piston.

9. The vehicle power steering system of claim 8, also including a first pressure transducer having a first pressure output and operatively connected to the right-turn side of the hydraulic piston and a second pressure transducer having a second pressure output and operatively connected to the left-turn side of the hydraulic piston.

10. The vehicle power steering system of claim 9, wherein the controller calculates a pressure difference between the first pressure output and the second pressure output.

11. The vehicle power steering system of claim 10, wherein the controller adjusts the voltage difference in a predetermined manner based on a comparison of the pressure difference to the voltage difference.

12. The vehicle power steering system of claim 11, wherein the controller calculates the first and second control voltages based on the adjusted voltage difference.

13. The vehicle power steering system of claim 7, wherein the second cylinder includes first and second biasing magnets disposed, respectively, under the first and second Hall sensors to create a baseline magnetic field.

14. A vehicle power steering system comprising:
a) a first cylinder having a sweep magnet and fixedly connected to a first end of a twistable steering torsion bar wherein the first end is fixedly connected to a vehicle steering wheel;
b) a second cylinder having circumferentially spaced apart first and second Hall sensors and fixedly connected to a second end of the steering torsion bar, wherein the second cylinder is substantially coaxially aligned with the first cylinder, and wherein the first and second Hall sensors have corresponding first and second voltage outputs and are disposed proximate the sweep magnet such that the first and second voltage outputs are functions of steering wheel torque when the vehicle steering wheel is turned by a driver;
c) a hydraulic-power-steering-system, electrically-actuated pressure-control valve; and
d) a controller which calculates a voltage difference between the first voltage output and the second voltage output and which outputs a control voltage to the pressure-control valve based on the voltage difference.

15. The vehicle power steering system of claim 14, also including a hydraulic piston having a right-turn side and a left-turn side and operatively connected to right and left wheel tie rods, also including right and left electric valves, wherein the right electric valve is disposed between and in fluid communication with the pressure-control valve and the right-turn side of the hydraulic piston, wherein the left electric valve is disposed between and in fluid communication with the pressure-control valve and the left-turn side of the hydraulic piston, wherein the controller opens the right or left electric valve depending on the sign of the voltage difference.

16. The vehicle power steering system of claim 15, also including a first pressure transducer having a first pressure output and operatively connected to the right-turn side of the hydraulic piston and a second pressure transducer having a second pressure output and operatively connected to the left-turn side of the hydraulic piston.

17. The vehicle power steering system of claim 16, wherein the controller calculates a pressure difference between the first pressure output and the second pressure output.

18. The vehicle power steering system of claim 17, wherein the controller adjusts the voltage difference in a predetermined manner based on a comparison of the pressure difference to the voltage difference.

19. The vehicle power steering system of claim 18, wherein the controller calculates the first and second control voltages based on the adjusted voltage difference.

20. The vehicle power steering system of claim 14, wherein the second cylinder includes first and second biasing magnets disposed, respectively, under the first and second Hall sensors to create a baseline magnetic field.
